(19) United States
(12) Patent Application Publication
(10) Pub. No.: US 2016/0031472 A1
(43) Pub. Date: Feb. 4, 2016

(54) PANEL SEALING APPARATUS AND A METHOD OF ASSEMBLING THE PANEL SEALING APPARATUS

(71) Applicant: GM GLOBAL TECHNOLOGY OPERATIONS LLC, Detroit, MI (US)

(72) Inventors: Todd E. Allen, Lake Orion, MI (US); Seung H. Lee, Troy, MI (US)

(21) Appl. No.: 14/445,550

(22) Filed: Jul. 29, 2014

(51) Int. Cl. B62D 1/16; F16J 15/16; B62D 3/02

(52) U.S. Cl. CPC B62D 1/16; B62D 3/02; F16J 15/16

(57) ABSTRACT

A panel sealing apparatus and a method of assembling the panel sealing apparatus are disclosed. The apparatus includes a panel defining an aperture and a sealing assembly. The sealing assembly includes a first component formed of an elastomeric material and a second component formed of a rigid material. The second component at least partially surrounds the first component and is secured to the first component to form a unit. The sealing assembly further includes a connector configured to be attached to the panel in the aperture separately from the unit. The unit is attached to the connector after placement of the connector in the aperture to couple the unit to the panel.

### TECHNICAL FIELD

The present disclosure relates to a panel sealing apparatus and a method of assembling the panel sealing apparatus.

### BACKGROUND

Vehicles can include a dash panel or bulkhead that separates a passenger compartment from an engine compartment. A steering shaft passes through a hole in the dash panel such that a portion of the steering shaft is disposed in the passenger compartment and another portion of the steering shaft is disposed in the engine compartment. A steering wheel is attached to the steering shaft and disposed in the passenger compartment to allow a user to steer the vehicle. A seal is disposed about the steering shaft to minimize communication between the passenger compartment and the engine compartment via the hole in the dash panel. The seal can be bolted to the dash panel in which a larger packaging space is utilized. Alternatively, a compression seal can be utilized which has two pieces, one piece to overlap one side of the dash panel and another piece to overlap the other side of the dash panel. However, the compression seal can shift due to dynamic loads or different sized steering shafts being utilized which can allow excess communication through the hole of the dash panel.

### SUMMARY

The present disclosure provides a panel sealing apparatus including a panel defining an aperture and a sealing assembly. The sealing assembly includes a first component formed of an elastomeric material and a second component formed of a rigid material. The second component at least partially surrounds the first component and is secured to the first component to form a unit. The sealing assembly further includes a connector configured to be attached to the panel in the aperture separately from the unit. The unit is attached to the connector after placement of the connector in the aperture to couple the unit to the panel.

The present disclosure also provides a panel sealing apparatus for a vehicle. The apparatus includes a dash panel defining an aperture and a steering column disposed through the aperture. The steering column is selectively rotatable about a longitudinal axis. The apparatus also includes a sealing assembly. The sealing assembly includes a first component formed of an elastomeric material and a second component formed of a rigid material. The second component at least partially surrounds the first component and is secured to the first component to form a unit. The steering column is disposed through the unit. The sealing assembly also includes a connector configured to be attached to the panel in the aperture separately from the unit, with the unit attached to the connector after placement of the connector in the aperture to couple the unit to the dash panel.

The present disclosure further provides a method of assembling a panel sealing apparatus. The method includes attaching a connector to a panel in an aperture of the panel. The method also includes attaching a unit to the connector after attaching the connector to the panel in the aperture. The unit includes a first component formed of an elastomeric material and a second component at least partially surrounding the first component. The second component is secured to the first component and is formed of a rigid material.

The detailed description and the drawings or Figures are supportive and descriptive of the disclosure, but the scope of the disclosure is defined solely by the claims. While some of the best modes and other embodiments for carrying out the claims have been described in detail, various alternative designs and embodiments exist for practicing the disclosure defined in the appended claims.

### BRIEF DESCRIPTION OF THE DRAWINGS

FIG. 1 is a schematic exploded perspective view of a panel sealing apparatus.

FIG. 2 is a schematic fragmentary cross-sectional view of the panel sealing apparatus, with a connector attached to a panel and a unit spaced from the connector.

FIG. 3 is a schematic fragmentary cross-sectional view of the panel sealing apparatus, with a sealing assembly coupled to the panel.

FIG. 4 is a schematic fragmentary enlarged cross-sectional view of a clip of the connector and a lip of a second component engaging each other.

### DETAILED DESCRIPTION

Those having ordinary skill in the art will recognize that terms such as “above”, “below”, “upward”, “up”, “downward”, “down”, “top”, “bottom”, “left”, “right”, “back”, “forth”, etc., are used descriptively for the figures, and do not represent limitations on the scope of the disclosure, as defined by the appended claims.

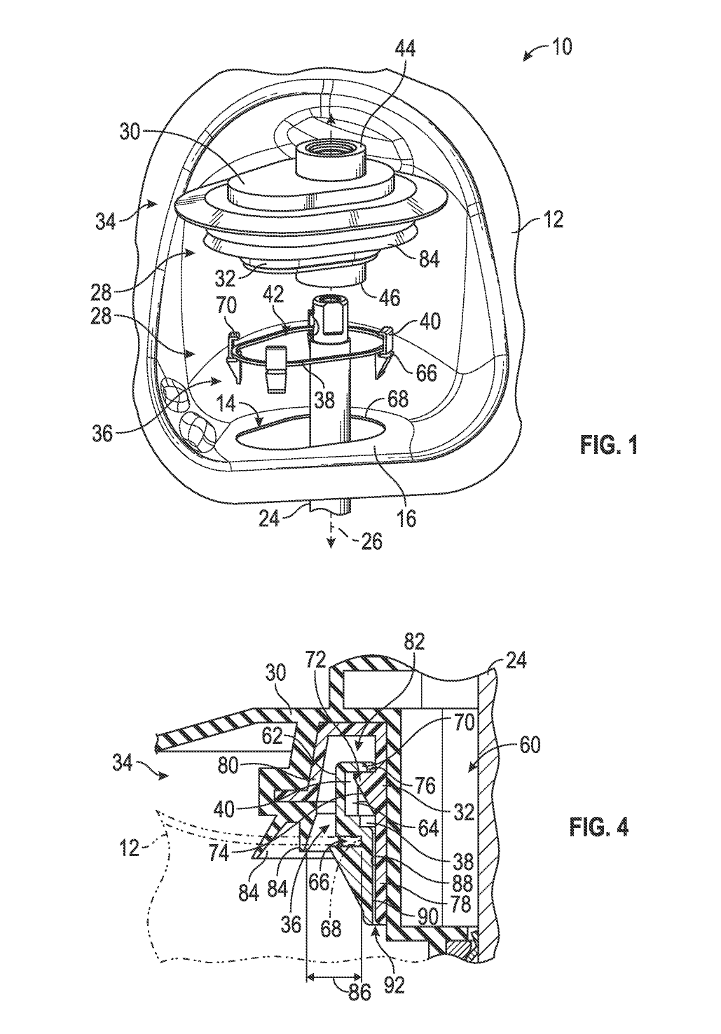

Referring to the Figures, wherein like numerals indicate like or corresponding parts throughout the several views, a panel sealing apparatus 10 is generally shown in FIG. 1. The panel sealing apparatus 10 can be utilized in many different applications. For example, the panel sealing apparatus 10 can be utilized in a vehicle application or a non-vehicle application. Therefore, in certain embodiments, the panel sealing apparatus 10 is for a vehicle.

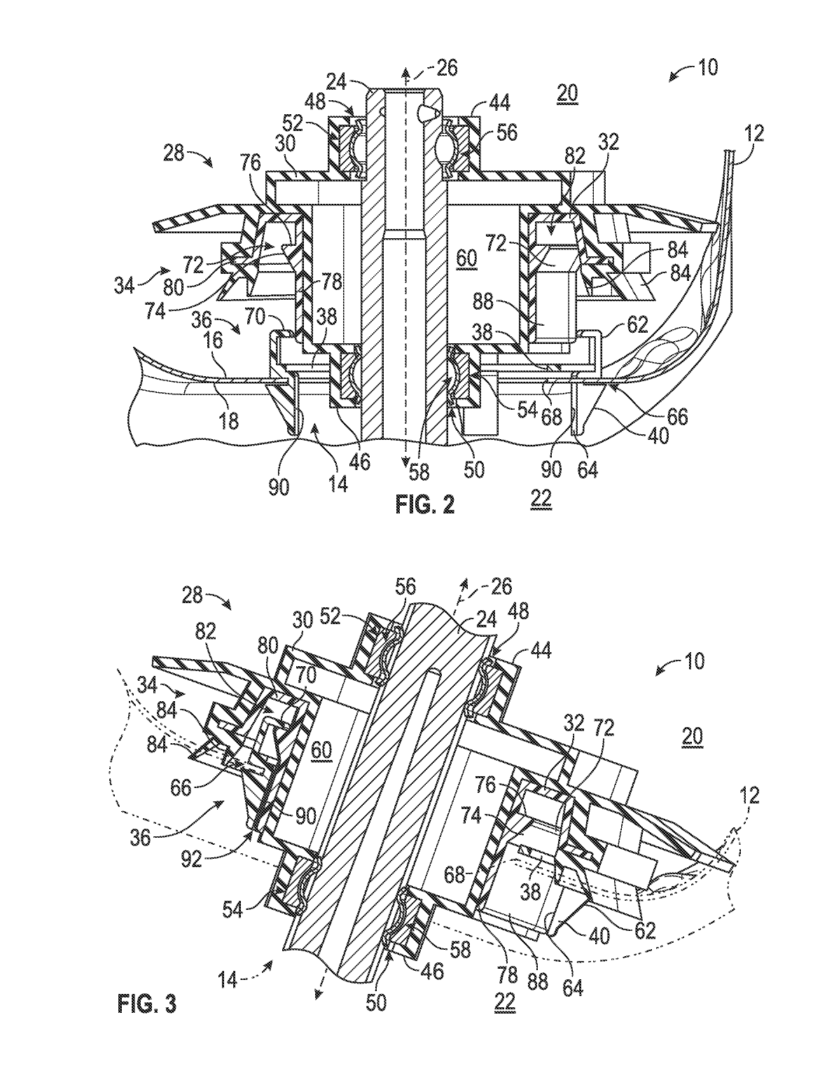

Continuing with FIGS. 1 and 2, the panel sealing apparatus 10 includes a panel 12 defining an aperture 14. The panel 12 can be any suitable configuration, and FIG. 1 illustrates one suitable configuration. The panel 12 can include a first surface 16 and a second surface 18 opposing each other. When the panel 12 is utilized in the vehicle application, the first surface 16 can generally face a passenger compartment 20 of the vehicle and the second surface 18 can generally face an engine compartment 22 of the vehicle. The passenger compartment 20 can contain one or more seats for passenger(s) to utilize. The engine compartment 22 can contain one or more of an engine, a transmission, etc. Alternatively, instead of the engine compartment 22, the second surface 18 can generally face a storage compartment. Therefore, in the vehicle application, the panel 12 can at least partially split apart the passenger compartment 20 and the engine compartment 22/storage compartment. In the vehicle application, the panel 12 can be referred to as a dash panel, and the dash panel can define the aperture 14.

The panel sealing apparatus 10 can further include a shaft 24 disposed through the aperture 14 of the panel 12 along a longitudinal axis 26. For example, in the vehicle application, the shaft 24 can be a steering column and the steering column is disposed through the aperture 14. A steering wheel is attached to the steering column and the steering wheel is disposed in the passenger compartment 20 to allow one of the passengers to steer the vehicle. When the shaft 24 is the steering column, the steering column is selectively rotatable about the longitudinal axis 26. Therefore, in certain embodiments, the shaft 24 is selectively rotatable about the longitudinal axis 26.

Referring to FIGS. 1-3, the panel sealing apparatus 10 further includes a sealing assembly 28. The sealing assembly 28 includes a first component 30 formed of an elastomeric material and a second component 32 formed of a rigid material. The elastomeric material of the first component 30 can be any suitable flexible material. For example, the elastomeric material of the first component 30 can be rubber. The first component 30 can be referred to as a rubber boot. The rigid material of the second component 32 can be any suitable material that generally allows the second component 32 to maintain its configuration. For example, the rigid material of the second component 32 can be plastic or metal.

The second component 32 at least partially surrounds the first component 30 and is secured to the first component 30 to form a unit 34. Generally, the shaft 24 is disposed through the unit 34 as further discussed below. In the vehicle application, the steering column is disposed through the unit 34. For example, the first and second components 30, 32 can be molded to each other, such as by injection molding, etc. The first and second components 30, 32 can be molded at the same time or one of the components 30, 32 can be molded to the other one of the components 30, 32. As another example, the first and second components 30, 32 can be secured to each other by adhesive, etc.

Continuing with FIGS. 1-3, the sealing assembly 28 further includes a connector 36 configured to be attached to the panel 12 in the aperture 14 separately from the unit 34. The unit 34 is attached to the connector 36 after placement of the connector 36 in the aperture 14 to couple the unit 34 to the panel 12, or in the vehicle application, couple the unit 34 to the dash panel. Therefore, once the connector 36 is attached to the panel 12, the unit 34 is then attached to the connector 36 in a separate operation. FIG. 2 illustrates the connector 36 attached to the panel 12 in the aperture 14 and FIG. 3 illustrates the unit 34 secured to the connector 36. By attaching the connector 36 to the panel 12 first, the effort to attach the unit 34 to connector 36 to couple the unit 34 to the panel 12 is reduced, which reduces fatigue during installation.

Referring to FIGS. 1 and 2, the connector 36 can include a band 38 and a plurality of clips 40 attached to the band 38. Each of the clips 40 are attached to the panel 12 in the aperture 14 (see FIG. 2). In certain embodiments, each of the clips 40 are spaced from each other about the band 38 (see FIG. 1). The band 38 can be continuous or non-continuous. For a non-continuous band 38, the band 38 can end at one or more of the clips 40 such that the band 38 is split into one or more pieces. It is to be appreciated that any suitable number of clips 40 can be attached to the band 38, i.e., one or more, and the clip(s) 40 can be in any suitable location about the band 38. The clips 40 and the band 38 can be attached to each other by adhesive, injection molding, fasteners, etc.

In certain embodiments, the band 38 and the clips 40 are integrally formed to each other, i.e., formed as one piece. Therefore, the band 38 and the clips 40 can be injected molded as one piece. The band 38 and the clips 40 can be formed of a polymeric material. For example, the polymeric material of the clips 40 and the band 38 can be plastic. It is to be appreciated that the clips 40 and the band 38 can be formed of materials other than polymeric material.

The band 38 allows movement of the clips 40 relative to each other to provide adjustability of the connector 36 when attaching the clips 40 to the panel 12 in the aperture 14. The band 38 can be flexible and/or movable to allow movement of the clips 40 relative to each other. For example, the band 38 can be narrow (as shown in the Figures) which allows the band 38 to flex and move.

The clips 40 support the unit 34 to maintain the second component 32 relative to the clips 40. A portion of the clips 40 is formed of a thickness that generally allows the clips 40 to maintain its position/configuration and can generally support the unit 34.

As best shown in FIG. 1, the band 38 can define an opening 42 that generally complements the aperture 14 of the panel 12. It is to be appreciated that the band 38 can be any suitable configuration. When the connector 36 is attached to the aperture 14 in the opening 42, the opening 42 generally aligns with the aperture 14 and the shaft 24 can extend through both the opening 42 and the aperture 14. Furthermore, the unit 34 can extend through both the opening 42 and the aperture 14.

Referring to FIGS. 2 and 3, the first component 30 can include a first end 44 and a second end 46 spaced from each other. The first end 44 can define a first hole 48 along the longitudinal axis 26 for receiving the shaft 24. The second end 46 can define a second hole 50 along the longitudinal axis 26 for receiving the shaft 24. Generally, the first end 44 faces into the passenger compartment 20 and the second end 46 faces into the engine compartment 22.

Continuing with FIGS. 2 and 3, the first component 30 can define a first pocket 52 adjacent to the first end 44. The first component 30 can define a second pocket 54 adjacent to the second end 46. A first bearing 56 or bushing can be secured to the first component 30 in the first pocket 52, with the shaft 24 disposed through the first bearing 56. In certain embodiments, a second bearing 58 or bushing can be secured to the second component 32 in the second pocket 54, with the shaft 24 disposed through the second bearing 58. The first and second bearings 56, 58 minimize frictional engagement between the first component 30 and the shaft 24 when the shaft 24 rotates. The first and second bearings 56, 58 can be spaced from each other. For example, in certain embodiments, the first bearing 56 is disposed along the passenger compartment 20 side of the panel 12 and the second bearing 58 is disposed along the engine compartment 22 side of the panel 12. It is to be appreciated that the first and second pockets 52, 54, as well as the first and second bearings 56, 58 can be in any suitable location.

The first component 30 can define a cavity 60 between the first and second ends 44, 46. In certain embodiments, the cavity 60 is disposed between the first and second pockets 52, 54. The cavity 60 allows movement of the first component 30 to adjust for build variations, different shaft diameters, shaft tolerances, or coupling the shaft 24 with other components.

When the sealing assembly 28 is attached or secured to the panel 12 and the shaft 24 is inserted through the first and second ends 44, 46 of the first component 30, the sealing assembly 28 and the shaft 24 cooperate to minimize communication through the aperture 14 of the panel 12. Therefore, sound or noise, debris, water, fluid, etc., between the engine compartment 22 and the passenger compartment 20 is minimized through the aperture 14 when the sealing assembly 28 is attached or secured to the panel 12 and the shaft 24 is inserted through the first and second ends 44, 46 of the first component 30.

Therefore, the unit 34 is inserted in the opening 42 of the band 38 to minimize communication through the aperture 14. Said differently, the unit 34 is inserted in the opening 42 of the band 38 to impede or obstruct the aperture 14. During assembly, the unit 34 is inserted in the opening 42 of the band 38 and into the aperture 14 of the panel 12, and continues into engagement with the clips 40 of the connector 36 which couples the unit 34 to the panel 12 through the connectors 36.

Turning to FIGS. 1 and 4, each of the clips 40 can include a first side 62 and a second side 64 opposing the first side 62. The first side 62 of each of the clips 40 can define a slot 66 to receive the panel 12 and attach the connector 36 to the panel 12. Therefore, the slot 66 of each of the clips 40 captures an edge 68 of the panel 12 adjacent to the aperture 14 of the panel 12. As such, a portion of the clips 40 overlap a portion of the panel 12. During assembly, the panel 12 engages each of the clips 40 in the slot 66 which maintains the position of the clips 40 relative to the panel 12 so that the next operation can be performed without having to readjust the clips 40. In other embodiments, the second side 64 of each of the clips 40 can define the slot 66. It is to be appreciated that the slot 66 can be in any suitable location on the clips 40.

When the clips 40 are attached to the panel 12, a first portion of each of the clips 40 extend toward the passenger compartment 20 and a second portion of each of the clips 40 extend toward the engine compartment 22. In other words, the first portion of each of the clips 40 extend outwardly away from the first surface 16 of the panel 12 and the second portion of each of the clips 40 extend outwardly away from the second surface 18 of the panel 12. Specifically, the first portion of the clips 40 extend generally along the longitudinal axis 26 toward the passenger compartment 20 and the second portion of the clips 40 extend generally along the longitudinal axis 26 toward the engine compartment 22.

Referring to FIGS. 1 and 4, each of the clips 40 includes a tab 70. The second component 32 engages the tab 70 of each of the clips 40 to attach the unit 34 to the connector 36. Specifically, during attachment of the unit 34 to the connector 36, the second component 32 engages the tab 70. Therefore, as the unit 34 is inserted through the aperture 14, the tabs 70 engage the second component 32 and attach the unit 34 to the connector 36. Generally, the tabs 70 bias back as the unit 34 is being inserted through the aperture 14 and once the unit 34 is in its final position, the tabs 70 bias forward to attach the unit 34 to the clips 40. The tab 70 of each of the clips 40 is formed of a thickness to allow the tabs 70 to bias back and forth, as well as attach the unit 34 to the connector 36. In certain embodiments, the tab 70 can face away from the first side 62. In other embodiments, the tab 70 can face away from the second side 64. It is to be appreciated that the tab 70 can be in any suitable location on the clips 40.

Referring to FIGS. 2-4, the second component 32 can include a lip 72 engaging the tab 70 of each of the clips 40 to attach the unit 34 to the connector 36. Specifically, the lip 72 can include a ramp 74 and a platform 76. The tab 70 of each of the clips 40 can bias along the ramp 74 and the platform 76 to attach the unit 34 to the connector 36. Specifically, the tab 70 of each of the clips 40 can move back and forth as the lip 72 of the second component 32 engages respective tabs 70 during attachment of the unit 34 to the connector 36. Therefore, as the unit 34 is being inserted through the aperture 14, the tab 70 of each of the clips 40 ride along the ramp 74 to bias outwardly away from the longitudinal axis 26 and once the tab 70 of each of the clips 40 reach the platform 76, the tab 70 of each of the clips 40 bias toward the longitudinal axis 26 such that a portion of the tab 70 of each of the clips 40 overlap a portion of the platform 76. The overlapping engagement of the tab 70 and the platform 76 attaches or secures together the unit 34 and the connector 36, and more specifically, couples or secures the sealing assembly 28 to the panel 12. The configuration of the clips 40 and the lip 72 of the second component 32 cooperate to reduce the amount of effort needed to couple the sealing assembly 28 to the panel 12 during assembly.

Continuing with FIGS. 2-4, the second component 32 can include a body 78 and a flange 80 extending from the body 78. The flange 80 can overlap a portion of the body 78 in a spaced relationship such that the flange 80 and the body 78 define a space 82 to allow the tab 70 of each of the clips 40 to bias in the space 82. The lip 72 can be continuous or non-continuous about the body 78 of the second component 32. When the lip 72 is non-continuous, the clips 40 align with the lip 72.

The lip 72 can be partially or entirely disposed in the space 82. For example, the ramp 74 can be at least partially disposed in the space 82 and the platform 76 can be disposed in the space 82. During assembly, as the unit 34 is inserted into the aperture 14 of the panel 12, the tab 70 of each of the clips 40 enters the space 82 and engages the platform 76 in the space 82 as shown in FIG. 4.

The first component 30 can include at least one sealing lip 84. In certain embodiments, the first component 30 can include a plurality of sealing lips 84. The sealing lips 84 engage the first surface 16 of the panel 12 when the unit 34 is attached to the connector 36 to minimize communication through the aperture 14 of the panel 12. Utilizing the sealing assembly 28 described herein can reduce the amount of space 82 utilized for the interface between the panel 12 and the sealing assembly 28. Specifically, the connector 36 and the unit 34 are designed to allow a distance 86 between the edge 68 of the panel 12 and the sealing lip 84 proximal to the edge 68 of the panel 12 to be decreased, which reduces the amount of packaging space 82 utilized with the sealing assembly 28. For example, the distance 86 can be from about 8.0 millimeters to about 10.0 millimeters.

The body 78 of the second component 32 can have an outer surface 88 facing the second side 64 of each of the clips 40. The outer surface 88 and at least a portion of the second side 64 of each of the clips 40 are complementary to each other to limit movement of the second component 32 relative to the clips 40. Specifically, the second side 64 of each of the clips 40 can include an abutment 90 and when the body 78 of the second component 32 engages the abutment 90, the abutment 90 limits movement of the second component 32. The portion of the second side 64 can be further defined as the abutment 90. For example, when the unit 34 is attached to the clips 40 and the shaft 24 shifts inside the aperture 14, the second component 32 can slightly move radially relative to the longitudinal axis 26 into engagement with the abutment 90, and this engagement will prevent further radially movement of the second component 32 in that direction.

The outer surface 88 and the abutment 90 can define a small gap 92 therebetween such that engagement between the outer surface 88 and the abutment 90 is minimized during assembly of the unit 34 to the connector 36. Minimizing engagement between the unit 34 and the connector 36 during assembly, reduces the effort utilized to assemble these parts 34, 36. In other words, minimizing frictional engagement between the outer surface 88 of the second component 32 and the abutment 90 of the clips 40 reduces the effort utilized to assembly the unit 34 to the connector 36.

The sealing assembly 28 described herein improves sealing performance of the aperture 14. Furthermore, the sealing assembly 28 provides ergonomic benefits by reducing the effort needed to couple the sealing assembly 28 to the panel 12. These ergonomic benefits can also reduce worker fatigue and reduce assembly time. Specifically, the force utilized to attach the unit 34 to the connectors 36 is reduced to 85.0 newton or lower by utilizing the sealing assembly 28 described herein.

The present disclosure also provides a method of assembling the panel sealing apparatus 10. The method includes attaching the connector 36 to the panel 12 in the aperture 14 of the panel 12 and attaching the unit 34 to the connector 36 after attaching the connector 36 to the panel 12 in the aperture 14. Therefore, the connector 36 and the unit 34 are assembled in two separate operations which reduce the amount of effort utilized to couple the sealing assembly 28 to the panel 12. As discussed above, the unit 34 includes the first component 30 formed of the elastomeric material and the second component 32 at least partially surrounding the first component 30 and secured to the first component 30. As also discussed above, the second component 32 is formed of the rigid material.

Attaching the connector 36 to the panel 12 can include engaging the plurality of clips 40 of the connector 36 with the panel 12. Furthermore, engaging the clips 40 of the connector 36 with the panel 12 can include moving the clips 40 of the connector 36 toward the panel 12 such that the panel 12 is disposed in the slot 66 of each of the clips 40 to engage the clips 40 with the panel 12. Attaching the clips 40 to the panel 12 maintains the position of the clips 40 so that the next operation can be performed, i.e., so the unit 34 can then be attached to the connector 36. The slot 66 of each of the clips 40 are moved into engagement with the edge 68 of the panel 12 without the unit 34 interfering with the placement or engagement of the clips 40. Therefore, the connectors 36 are attached to the panel 12 with low effort.

Attaching the unit 34 to the connector 36 can include engaging the lip 72 of the second component 32 with the tab 70 of each of the clips 40 to attach the unit 34 to the connector 36. Furthermore, attaching the unit 34 to the connector 36 can also include inserting the unit 34 in the aperture 14 such that the clips 40 at least partially surround the second component 32. More specifically, attaching the unit 34 to the connector 36 can also include inserting the unit 34 in the aperture 14 and the opening 42 of the band 38. Therefore, once the clips 40 are placed, the force to snap the unit 34 into the clips 40 is reduced to about 85.0 newton or lower. This reduced amount of force improves worker ergonomics during assembly.

In certain embodiments, inserting the unit 34 in the aperture 14 can include inserting the unit 34 in the aperture 14 from the first surface 16 of the panel 12 toward the second surface 18 of the panel 12. Generally, the first surface 16 cooperates with the passenger compartment 20. Therefore, during assembly, the unit 34 is inserted in the aperture 14 from the passenger compartment 20, i.e., the unit 34 moves toward the engine compartment 22 from the passenger compartment 20 side of the panel 12. As best shown in FIG. 1, the configuration of features of the unit 34 allows insertion of the unit 34 into the aperture 14 from one direction.

The method can also include inserting the shaft 24 through the unit 34 after attaching the unit 34 to the connector 36. Therefore, the sealing assembly 28 is coupled to the panel 12 before the shaft 24 is disposed through the sealing assembly 28. As such, during assembly, the connector 36 is attached to the panel 12, then the unit 34 is attached to the connector 36, and then the shaft 24 is inserted through the unit 34. Specifically, inserting the shaft 24 through the unit 34 can include inserting the shaft 24 through the first and second holes 48, 50, the first and second pockets 52, 54 and the cavity 60. The shaft 24 abuts the first and second bearings 56, 58 inside the unit 34. Specifically, the bearings 56, 58 surround the shaft 24 once the shaft 24 is inserted through the sealing assembly 28.

While the best modes for carrying out the disclosure have been described in detail, those familiar with the art to which this disclosure relates will recognize various alternative designs and embodiments for practicing the disclosure within the scope of the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

1. A panel sealing apparatus comprising:
a panel defining an aperture;
a sealing assembly including:
a first component formed of an elastomeric material;
a second component formed of a rigid material, with the second component at least partially surrounding the first component and secured to the first component to form a unit; and
a connector configured to be attached to the panel in the aperture separately from the unit, with the unit attached to the connector after placement of the connector in the aperture to couple the unit to the panel.

2. The apparatus as set forth in claim 1 wherein the connector includes a band and a plurality of clips attached to the band, with each of the clips attached to the panel in the aperture.

3. The apparatus as set forth in claim 2 wherein the band defines an opening that generally complements the aperture of the panel, and wherein the unit is inserted in the opening of the band to minimize communication through the aperture.

4. The apparatus as set forth in claim 2 wherein the band allows movement of the clips relative to each other to provide adjustability of the connector when attaching the clips to the panel in the aperture, and wherein the clips support the unit to maintain the second component relative to the clips.

5. The apparatus as set forth in claim 2 wherein each of the clips are spaced from each other about the band.

6. The apparatus as set forth in claim 2 wherein each of the clips include a first side and a second side opposing the first side, with the first side of each of the clips defining a slot to receive the panel and attach the connector to the panel.

7. The apparatus as set forth in claim 6 wherein each of the clips includes a tab, with the second component engaging the tab of each of the clips to attach the unit to the connector.

8. The apparatus as set forth in claim 7 wherein the second component includes a lip engaging the tab of each of the clips to attach the unit to the connector.

9. The apparatus as set forth in claim 8 wherein the lip includes a ramp and a platform, with the tab of each of the clips being biasable along the ramp and the platform to attach the unit to the connector.

10. The apparatus as set forth in claim 7 wherein the second component includes a body and a flange extending from the body, with the flange overlapping a portion of the body in a spaced relationship such that the flange and the body define a space to allow the tab of each of the clips to bias in the space.

11. The apparatus as set forth in claim 6 wherein the second component includes a body having an outer surface facing the second side of each of the clips, with the outer surface and at least a portion of the second side of each of the clips complementary to each other to limit movement of the second component relative to the clips.

12. A method of assembling a panel sealing apparatus, the method comprising:
attaching a connector to a panel in an aperture of the panel; and
attaching a unit to the connector after attaching the connector to the panel in the aperture;
with the unit including a first component formed of an elastomeric material and a second component at least partially surrounding the first component and secured to the first component, and with the second component formed of a rigid material; and wherein a sealing assembly includes the connector and the first and second components.

13. The method as set forth in claim 12 wherein attaching the connector to the panel further comprises engaging a plurality of clips of the connector with the panel.

14. The method as set forth in claim 13 wherein engaging the clips of the connector with the panel further comprises moving the clips of the connector toward the panel such that the panel is disposed in a slot of each of the clips to engage the clips with the panel.

15. The method as set forth in claim 13 wherein attaching the unit to the connector further comprises engaging a lip of the second component with a tab of each of the clips to attach the unit to the connector.

16. The method as set forth in claim 15 wherein attaching the unit to the connector further comprises inserting the unit in the aperture such that the clips at least partially surround the second component.

17. The method as set forth in claim 16 wherein inserting the unit in the aperture further comprises inserting the unit in the aperture from a first surface of the panel toward a second surface of the panel, with the first surface cooperating with a passenger compartment.

18. The method as set forth in claim 12 further comprising inserting a shaft through the unit after attaching the unit to the connector.

19. A panel sealing apparatus for a vehicle, the apparatus comprising:
a dash panel defining an aperture;
a steering column disposed through the aperture and selectively rotatable about a longitudinal axis;
a sealing assembly including:
a first component formed of an elastomeric material;
a second component formed of a rigid material, with the second component at least partially surrounding the first component and secured to the first component to form a unit, with the steering column disposed through the unit; and
a connector configured to be attached to the panel in the aperture separately from the unit, with the unit attached to the connector after placement of the connector in the aperture to couple the unit to the dash panel.
